(19) United States
(12) Patent Application Publication
(10) Pub. No.: US 2004/0199818 A1
(43) Pub. Date: Oct. 7, 2004

(54) Automated testing of web services

(75) Inventors: Michael G. Boilen, Kirkland, WA (US); David C. Kline, Bothell, WA (US)

Correspondence Address: LEE & HAYES PLLC, 421 W RIVERSIDE AVENUE SUITE 500, SPOKANE, WA, 99201

(73) Assignee: MICROSOFT CORP., REDMOND, WA (US)

(21) Appl. No.: 10/403,781

(22) Filed: Mar. 31, 2003

(51) Int. Cl. H04L 1/22

(52) U.S. Cl. 714/25

(57) ABSTRACT

Automated testing of web services includes automatically generating a test script. Test data is supplied to the test script from a test data file. The web service is tested using the test script and the test data. The web service then produces a result from the test data. The result of the test is automatically verified.

### TECHNICAL FIELD

The present invention generally relates to web services, and more particularly to techniques for automated testing of web services.

### BACKGROUND

The scale and pervasiveness of the Internet continues to increase, thereby giving users access to an increasing range of functionality. The ways in which a user may access the Internet has increased dramatically, from use of a specific numerical address to using browsers and search engines. Users may access a diverse range of websites to gain information on particular subjects and may even access data processing that is performed using user-supplied data. Additionally, a diverse range of devices may access the Internet, from game consoles to wireless phones and airplanes.

Web services extend the functionality of the Internet by providing a basis for software to connect to other software applications. Web services provide computer functionality in a way that may be used by a diverse range of systems, using different networks and protocols, to provide various functions. A web service typically provides a specific element of functionality to service a specific request, such as data relating to a topic, data processing, and the like. For instance, a web service may perform a mathematical function, return requested data such as stock ticker information, and the like.

Web services provide application logic that is programmatically available. For example, a web service may be called directly by an application and receive data in a format that may be accessed and processed directly by the application. By providing application logic that is programmatically available, web services may be accessed in a variety of ways. For example, a web service may be accessed by an application implemented internally within a computer, by a computer over an intranet, by a computer over the Internet, and the like. Additionally, a web service may use open Internet standards so that it may be accessed by a wide range of users in a seamless manner. For instance, an application running locally on a user's computer may access the web service using open Internet standards directly.

Testing a web service is difficult because of the wide range of web services available and ways of accessing them. Today, web services are tested by specially designed test code which is particular for each web service under test. Each developer wrote code for different test cases and applied the test cases in different ways and at different times, which is inefficient and had inconsistent results. The inconsistency of the testing results further made it difficult to fix bugs that were discovered because recreating the bug was difficult.

Therefore, there is a need for improved techniques for testing web services.

### SUMMARY

Automated testing of web services, without writing web service specific code, is described. To test a web service, a test script is automatically generated based on a structure of the web service. Test data is supplied to the test script from a test data file, which is used to fill-out the test script. The web service is tested using the test script by providing the test data as a test case to the web service. The web service then produces a result from the test data. The result of the test is automatically verified, such as through comparison with an expected result.

### BRIEF DESCRIPTION OF THE DRAWINGS

FIG. 1 illustrates an exemplary implementation of a web services environment including a testing device and web services.

FIG. 2 illustrates an exemplary implementation of a system having a testing device and web service.

FIG. 3 illustrates an exemplary process of generating a test script and invoking a method of a web service by a testing device.

FIG. 4 illustrates an exemplary XML file format of a test script shown as a tree having nodes.

FIG. 5 illustrates an exemplary implementation of testing a web service by invoking a method and verifying a result.

FIG. 6 is a block diagram depicting exemplary test scripts, test data files, results and expected results provided in an XML format corresponding to a structure of a web service.

FIG. 7 is a flow diagram of an exemplary implementation of generating a test script, supplying test data, invoking a method and verifying a result.

FIG. 8 is a flow diagram of an exemplary implementation of testing a web service in a first instance and a second instance.

FIG. 9 is a flow diagram of an exemplary implementation of a test engine to supply test data and test a web service.

FIG. 10 illustrates an XML object model for testing web services.

FIG. 11 illustrates components of an example of a computer environment, including a computer.

### DETAILED DESCRIPTION

The following disclosure describes techniques for testing web services. Web services include methods for accessing functionality provided by the web service and may use arguments for use by the methods. For example, Amazon.com (Amazon.com is a registered trademark of Amazon.com, Inc., of Seattle, Wash.) may provide a web service having methods for buying goods, such as books, DVDs, and the like. To find a particular book, a user specifies a name of the book, which is supplied as an argument for a method of a web service. For example, the web service Amazon.com has a method “query <book>” which accepts a user-supplied argument “Ulysses” to specify a particular book.

Web Service Environment

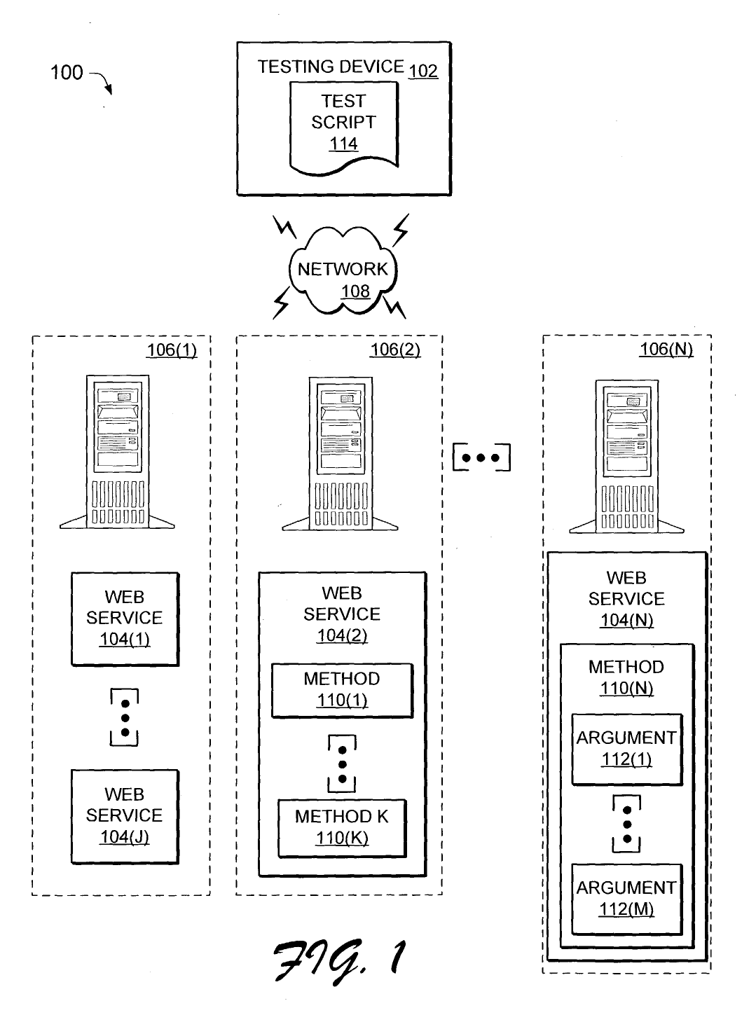

FIG. 1 shows a web services environment 100 in which a testing device 102 tests web services 104(1), 104(2) . . . 104(J) in an automated fashion without having to develop specialized testing software for each web service. Web services 104(1)-104(J) are hosted on web servers 106(1), 106(2) . . . 106(N) which are communicatively coupled to the testing device 102 using a network 108. The network 108 may include an intranet, Internet, and the like. Each web service 104 supports one or more methods 110. In the illustrated example, web service 104(2) supports multiple methods 110(1)-110(K), and web service 104(N) supports a single method 110(N). Additionally, each method 110 may support one or more arguments 112, such as method 110(N) including arguments 112(1)-112(M). To aid the following discussion, references to arguments 112(1)-112(M) in general will be referenced as “arguments 112,” likewise methods 110(1)-110(K) will be referenced as “methods 110,” and web services 104(1)-104((J) will be referenced as “web services 104.”

To test operation of web services 104, the testing device 102 uses a test script 114. The test script 114 addresses a hierarchical organization of web services 104 having methods 110, and arguments 112 used in conjunction with the methods 110. For example, the test script 114 may include a method 110 and argument 112(1) as a search term. The testing device 102, using the test script 114, may test the method 110 “query <book>” of the web service 104 with an argument 112(1) “Ulysses.” Web services testing may test operation of the web services 104, operation of the environment 100 in which the web services 104 are provided, behavior of the web services 104, as well as operation of the testing device 102.

### Web Service Testing Device

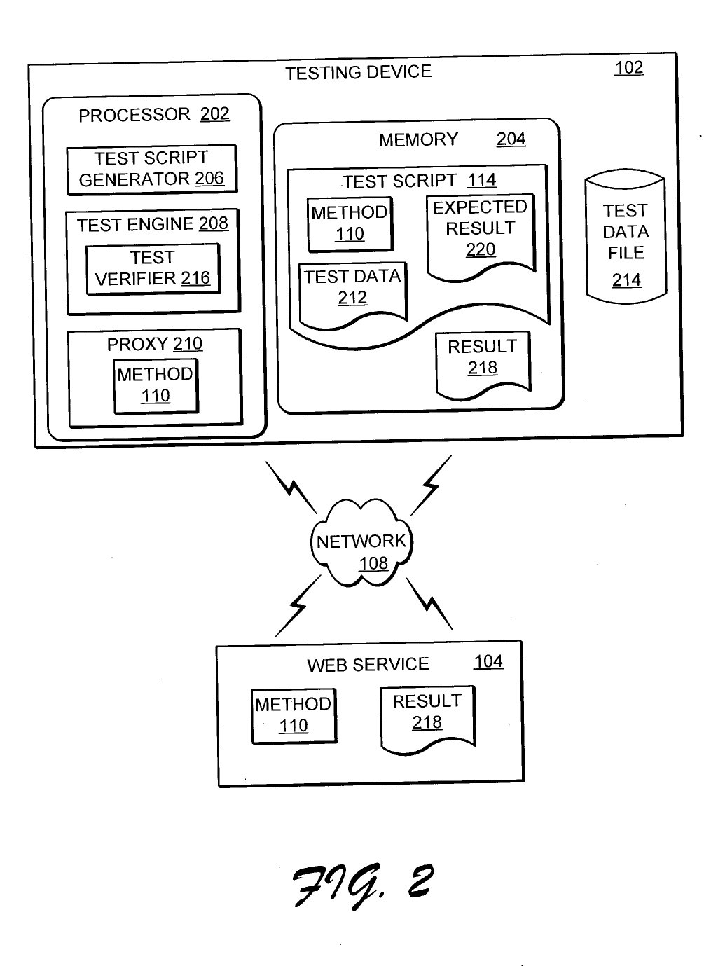

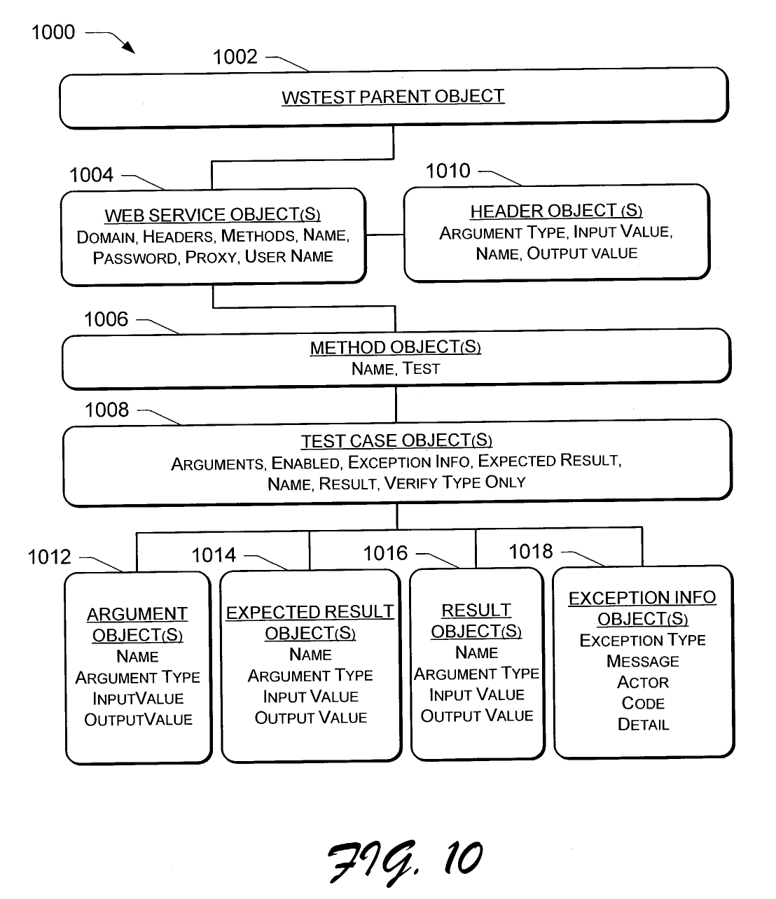

FIG. 2 shows a testing device 102 and a representative web service 104 in more detail. A testing device 102 includes a processor 202 for executing one or more programs of instructions and a memory 204 for storing the programs and data. The testing device 102 may be configured in a variety of ways, such as the computer 1002 described in relation to FIG. 10.

The testing device 102 has a test script generator 206 and a test engine 208, illustrated as being executed on the processor 202. The test script generator 206 is used to generate the test script 114 from a proxy 210. The proxy 210 may be thought of as an interface for the testing device 102 to communicate with the web service 104. The proxy 210 provides communication for the testing device 102 to call methods 110 which may operate in different execution environments, such as in a different application, on a different thread, in another process, remotely on another computer, and the like. The proxy 210 is located with the testing device 102 and exposes a replica of the method 110 of the web service 104. Through this exposed method 104, interaction with the proxy 210 effectively invokes the method 110 of the web service 104. The method 110 of the proxy 210 may be thought as an interface for the method 110 included on the web service 104 which actually does the “work”. The proxy 210 is used by the testing device 102 as if the method 110 was locally available. In the drawing figures, the method 110 is included as a part of the proxy 210 to represent exposure of the method 110 of the web service 104 locally on the testing device 102. By using the proxy 210, the method 110 available on the web service 104 may be accessed without the testing device 102 “knowing” where the method 110 is located and implemented.

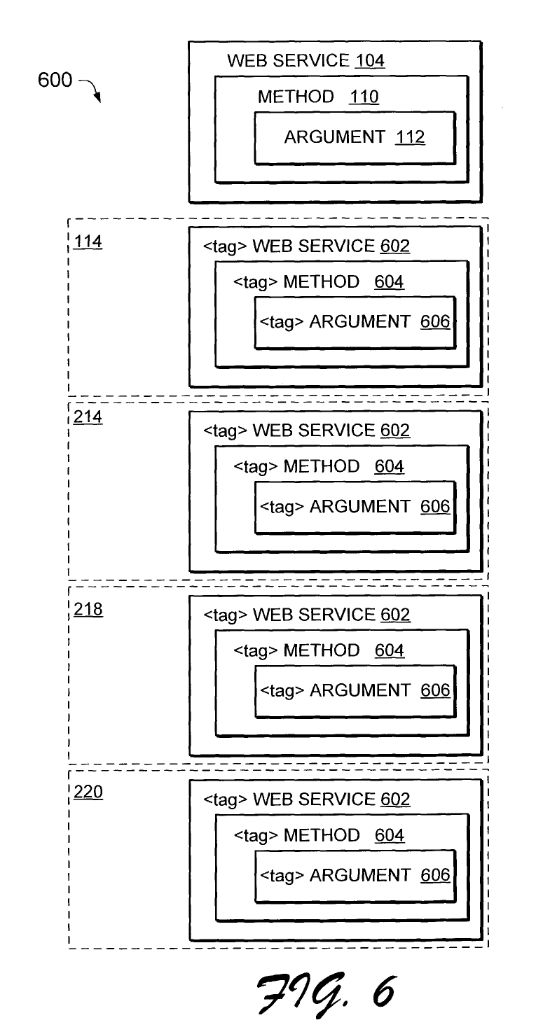

The method 110 exposed by the proxy 210 serves as a sign to the test script generator 206 what method 110, or methods 110, is available from the web service 104. The test script generator 206 uses the exposure to generate a test script 114 including the method 110 automatically from the proxy 210. For example, the test script 114 may include the method 110 as an indication of the particular method 110 exposed by the proxy 210, which may be used by a test engine 208 to supply test data 212. Thus, the included method 110 of the test script 114 may serve as a placeholder for further processing of the test script 114. A further discussion of indications may be found in relation to FIG. 6.

A test engine 208 supplies test data 212 to the test script 114 and uses the test script 114 to test the method 110 of the web service 104. The test engine 208 supplies test data 212 corresponding to the method 110 included in the test script 114 from a test data file 214 automatically. The test engine 208 then tests the web service 104, and specifically the method 110 of the web service 104, using the test script 114. Testing is performed by invoking the method 110 of the web service 104. In our continuing example of a method for finding books, testing may involve initiating operation of the method 110 to retrieve a list of books meeting a specific search term, like “Ulysses.”

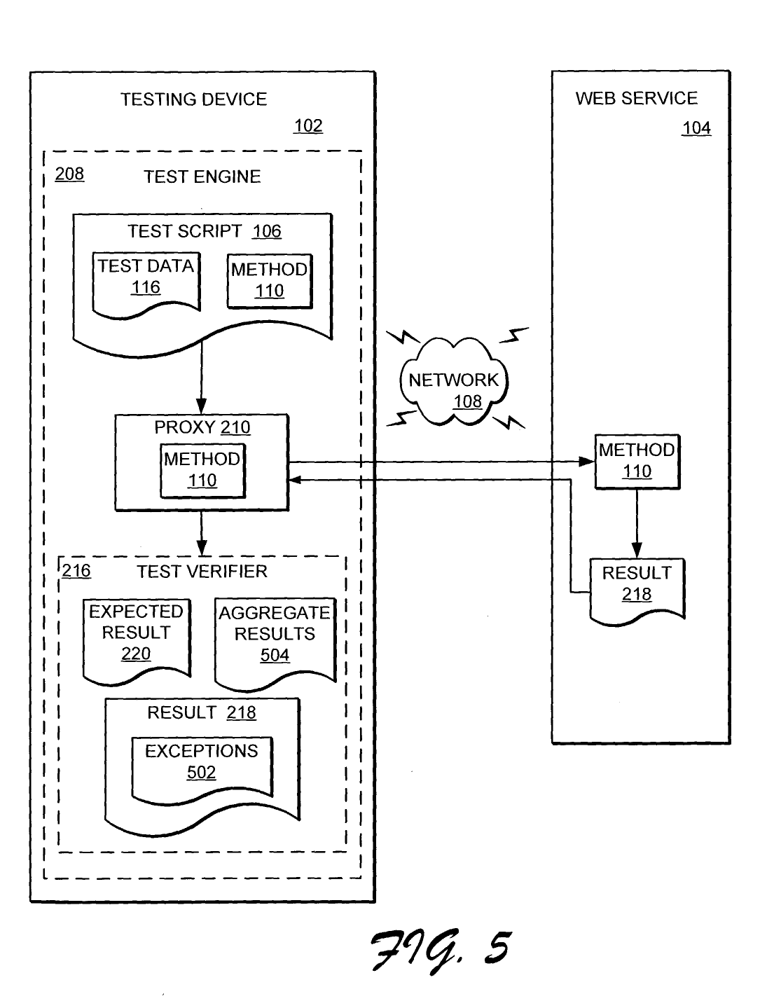

The test engine 208 may include a test verifier 216 for verifying a result 218 of a performed by the web service 104. For instance, the result 218 may include the list of books returned to the testing device 102 to be verified by the test verifier 216. The list of books received as a result 218 may then be compared with a listing of books of an expected result 220, which optionally may be included as part of the test script 114. The expected result 220 may be used to indicate a particular data type expected, data to be received, and the like. A further discussion of operation of the test verifier 216 may be found in relation to FIG. 5.

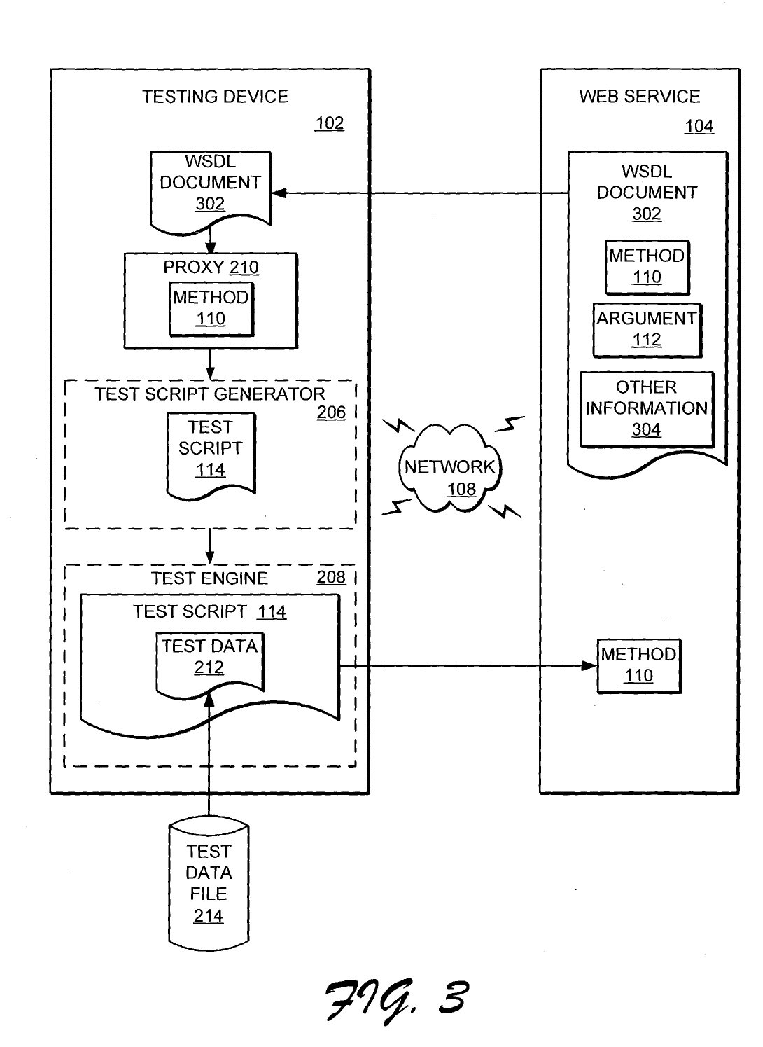

FIG. 3 shows a testing device 102 employing a test script generator 206 to generate a test script 114 and a test engine 208 which supplies test data 212 to test the web service 104 using the test script 114. A proxy 210 is created so that a test script generator 206 may generate a test script 114 based on the proxy 210 as previously described. To create the proxy 210, a document describing how to interact with a web service is used, such as a WSDL document 302 obtained from the web service 104. The WSDL document 302 describes operation of the web service 104, such as a description of the method 110 available from the web service 104, uniform resource locator (URL) for invoking the method 110, supported arguments 112, and other information 304 such as data types supported, output data type of results, and the like. A utility is used, such as WSDL. exe, to create the proxy 210 having the method 110 from the WSDL document 302. As described previously, the proxy 210 acts as an interface for interacting with the method 110 of the web service 104.

The test script generator 206 generates a test script 114 from the proxy 210 by programmatically emitting a test script 114 from the proxy 210. The test script 114 contains the method 110 and supported arguments 112. For instance, because the proxy 210 exposes the method 110 of the web service 104, the test script generator 206 may use this exposure to generate a test script 114 that has the method 110 included as a part of the test script 114.

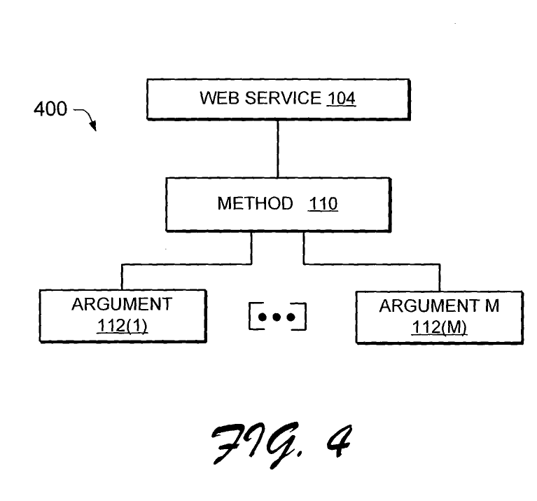

In one implementation, the test script 114 may be generated as an extensible markup language (XML) file with nodes of the XML file being the web service 104, method 110 and arguments 112. As shown in FIG. 4, a test script 114 XML file may be structured as a tree 400, with the web service 104, method 110, and arguments 112 being nodes of the tree 400.

Invoking the web service-based method 110 with test data 212 may be used to test behavior of the method 110 of the web service 106(N) in specific test cases, such as a result of the method 110 and argument 112(N) query “Ulysses. ” Therefore, the test engine 208 supplies test data 212 to the test script 114 so that a use of arguments 112 by the method 110 is tested. In this way, correct behavior of a web service 104 may be verified, such as proper execution of an algorithm, e.g. changing Fahrenheit to Celsius.

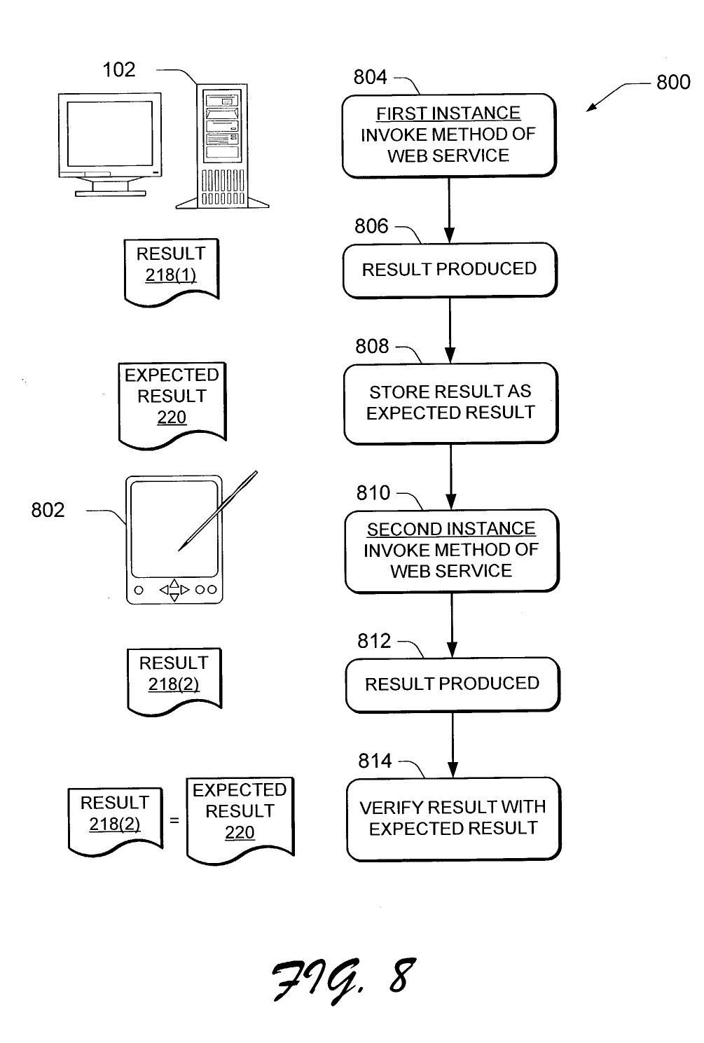

The test engine 208 obtains the test data 212 from a test data file 214. The test engine 208 supplies test data 212 corresponding to the web service 104, method 110 and arguments 112 as indicated in the test script 114. In other words, the test engine 208 supplies test data 212 to “fill-out” the test script 114, a further exemplary implementation of which is shown in relation to FIG. 8.

The test script 114 invokes the method 110 with the test data 212 to verify behavior of the method 110 when presented with specified test data 212, i. e. a test case. For example, a test case may include a method 110 “query <books>” with test data having the argument “Ulysses” to test whether a book by James Joyce was returned as a result 218 from the web service 104. Additionally, web services may be tested in a manner which enables “bugs” to be reproduced. For example, a user may report a bug to a web service provider that was encountered when interacting with a web service 104. The web service provider may produce a test to verify the bug and whether attempts to correct the bug were successful by generating a test case having parameters which caused the bug to occur.

FIG. 5 illustrates testing the web service 104 by invoking the method 110 and verifying the result 218. A test engine 208 uses a test script 114 to test a method 110 of a web service 104. The test script 114 includes the method 110 and provides test data 212 to be processed by the method 110. To invoke the method 110 of the web service 104, the test engine 208 uses the test script 114 to invoke the proxy 210, and particularly the method 110 of the proxy. The proxy 210 acts as an interface for the method 110 of the web service 104 so that it appears to the test engine 208 that the method 110 is available locally on the testing device 102. The proxy 210 takes the test data 212 and transfers the test data 212 over the network 108 to the web service 104 and invokes the method 110. The method 110 of the web service 104 produces a result 218 that is returned through the proxy 210. The proxy 210 then exposes the result 218 to the test engine 208.

The test engine 208 includes a test verifier 216 that verifies the result 218 with the expected result 220. Verification may be accomplished in a variety of ways. For example, a one-to-one comparison may be made between data included in the result 218 and data of the expected result 220 for each test case. Additionally, the result 218 may be verified with the expected result 220 based on type of data, such as number, characters, integers, format, and the like. For example, the expected result 220 may indicate that a number was to be returned, but not indicate a particular number. Therefore, if the result 218 is a number, the test verifier 216 may return an indication of successful completion of the test case to the testing device 102. Likewise, if the expected result 220 indicated a number, and the result 218 was a character, the test verifier 216 returns an indication that the test case failed.

The test verifier 216 may store exception data 502 from an exception encountered during the invocation of the method 110. In general, an exception is a situation that was not expected, and is not limited to program errors. An exception may be generated by hardware or software, such as by the web server 106(N) or the web service 104. Hardware exceptions include resets and interrupts. Software exceptions are more varied and may include a variety of situations that depart from expected behavior. The exception data 502 may be stored within a results 218 file.

Results 218 may be collected as an aggregate result 504 to enable easier interaction by a user. For example, the test engine 102 may test a plurality of web services 104 having multiple methods 110 that use multiple arguments 112. Therefore, a large number of test cases may be desirable to test the various permutations. The aggregate result 504 may supply a percentage of successful versus unsuccessful test cases, number of exceptions encountered, and the like.

FIG. 6 shows an exemplary testing structure 600 in which the test script 114, test data file 214, result 218 and expected result 220 are provided in an XML format that corresponds to the structure of the web service 104. Web service 104 has a structure in which methods 110 are included with the web services 104, and arguments 112 are included within the methods 110, as shown and described in relation to FIG. 1.

To follow the structure of the web service 104, the test script 114 has an XML format to supply indications of structural components of a web service. The test script 114 may identify a corresponding web service 104 with a web service tag 602. Additionally, methods 110 available from web services 104 are identified with a corresponding method tag 604. Likewise, arguments 112 included within the methods 110 are also identified using argument tags 606. The argument tags 606, included within the method tags 604, which are included within the web service tags 602, corresponds to the structure of the arguments 112 and methods 110 of the web services 104.

The corresponding structures provide interoperability between software functions, such as test script generator 206 and test engine 208 with how data is used by web services 104. The test script generator 206 may generate the test script 114 to have indications including the web service tags 602, method tags 604 and argument tags 606. The test engine 208 may then take advantage of the similar structures by identifying corresponding markup tags to supply test data 212 from the test data file 214 to the test script 114. The result 218 and the expected result 220 are also formatted as XML files to ease comparison. Thus, software using an XML format, such as the test engine 208, web services 104, test script generator 206 and test script verifier 216 may create, modify and compare data consistently.

### Web Service Testing Process

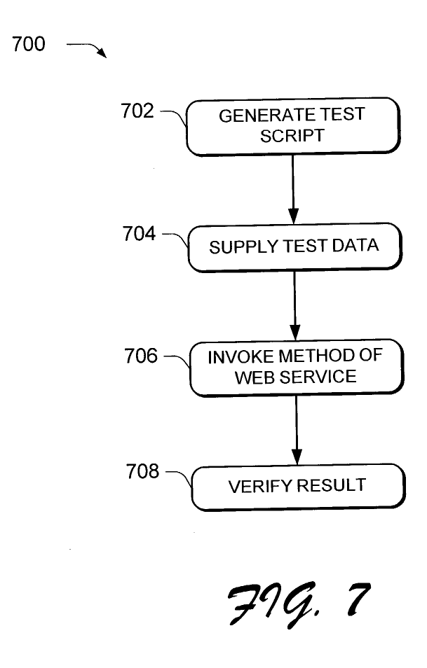

FIG. 7 is a flow diagram of an exemplary process 700 of producing a test script, testing a web service and verifying a result of the test. The process 700 is illustrated as a series of blocks representing individual operations or acts performed by a testing device 102 to execute web service 104 testing. The process 700 may be implemented in any suitable hardware, software, firmware, or combination thereof. In the case of software and firmware, process 700 represents a set of operations implemented as computer-executable instructions stored in memory and executable by one or more processors.

At block 702, the test script 106 is generated. The test script 106 is generated from the proxy 210 that exposes the method 110 of the web service 104. The test script 106 contains indications of the method 110, the web service 104 and argument 112 (if included) as a web service tag 602, method tag 604 and argument tag 606.

At block 704, test data 212 is supplied to the test script 114. The test data 212 is supplied from a test data file 214 which has markup tags which correspond to markup tags of the test script 114. The test data 212 is used to fill-out the test script 106 so that the correct behavior of the method 110 of the web service 104 is tested.

At block 706, the method 110 of the web service 104 is invoked using the test script 114. The test script 114 invokes the method 110 of the web service automatically by using a proxy 210 as an interface to the method 110 available from the web service 104. The test script 114 provides the test data 116 as a test case to the method 110.

At block 708, the result 218 of the invoking of the method 110 is verified. The result 218 may be verified by comparing a data type of the result 218 with an expected result 220. The result 218 may also be verified by comparing data of the result 218 with data of the expected result 220.

### Web Service Testing Process Using a Result from a Previous Instance

FIG. 8 is a flow diagram depicting an exemplary process 800 for creating an expected result 220 from a first result 218(1) and using it to verify a later result 218(2). A method 110 of a web service 104 may be tested in different instances to test both operation of the web service as well as operation of the testing devices. In this example, a first test is performed by a testing device 102 embodied as a general purpose computer (e.g., desktop PC, workstation, etc.) and a second test is performed by a low resource client 802 (e.g. a personal digital assistant (PDA), wireless phone, and the like). The low resource client 102 has limited hardware and software resources which limit what software that can be run and might limit its ability to interact with a web service 104. Therefore, to test operation of the low resource client 802, results 218(2) of invoking the method 110 by low resource client 802 may be compared with results 218(1) of invoking the method 110 by a computer 1002 (FIG. 10).

At block 804, the method 110 of the web service 104 is invoked in a first instance by a computer 1002. Invoking the method 110 may be performed as described in relation to FIG. 5. At block 806, a result 218(1) of the invocation in the first instance is produced, and at block 808, the result 218(1) is stored as an expected result 220. For example, markup tags of the result 218(1) may be changed to indicate it is an expected result 220.

At block 810, the method 110 of the web service 104 is invoked in a second instance. A result 218(2) of the invoking is produced at block 812. The result 218(2) is compared with the expected result 220 at block 814. In this way, testing a web service 104 may indicate possible problems of a testing device itself and not just operation of the web service 104. The testing instances may be performed under a variety of conditions, such as different points in time, using different testing devices, and the like.

### Exemplary Process of Test Engine Implementation

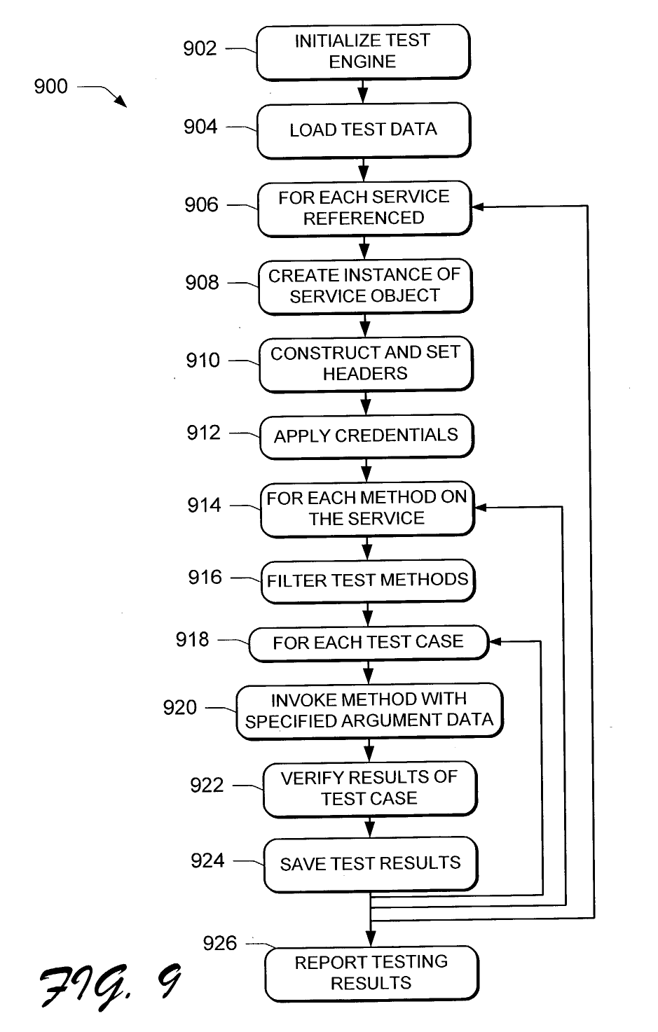

FIG. 9 shows a test process 900 implemented by the test engine 210. The process will be as described with reference to FIG. 3, a test script generator 206 produces a test script 114 and the test engine 210 supplies test data 212 to the test script 114 for use in testing the web service. The test data 212 is formatted as an XML file that describes web services 104, methods 110, and arguments 112. The test engine 208 proceeds through the test script 114 and supplies corresponding test data 212 from a test data file 214 based on the markup tags.

At block 902, a test engine 208 is initialized. The test engine 210, as well as the other programmatic structures of software previously described, may be implemented through use of object-oriented programming. FIG. 10 shows an XML object model 1000 used for testing a web service. An XML object model 1000 is a collection of objects that are used to access and manipulate data stored in an XML file. An XML file is modeled after a tree, in which each element in the tree is considered a node. Objects with various properties and methods represent the tree and its nodes, with each node containing actual data in the document. Thus, an XML object model serves to describe how objects (what is actually implemented by a computer) are organized. Using the XML object model 1000, a developer may create a file, navigate its structure, and modify object of the file. A serializer may be used to read an XML file into memory, so that its information may be accessed and retrieved using the XML object model 1000.

In the present implementation, a parent object, which will be referred to as web service test (WSTest) 1002, is called to test a web service 104. The web service test 1002 includes a web service object 1004, which has a method object 1006 having a test case object 1008. The test engine 208 of FIG. 9 proceeds through the XML object model 1000 as shown in FIG. 10 when supplying test data to the test script 114 and in invoking the method 110 of the web service 104. Therefore, the following discussion of the flow diagram of FIG. 9 will refer to objects as shown in the object model of FIG. 10. Components of the XML object model 1000 will be described in greater detail in conjunction with the exemplary test data file which follows this example. Additionally, components of the XML object model particular to verifying a test and storing results will be described in greater detail in conjunction with the exemplary test script having results data.

At block 904, the test engine 208 loads test assemblies, such as a test script 114 from a test generator 206 and a test data file 214. The test script 114 is an extensible markup language (XML) file with information described utilizing web services description language (WSDL) in a simple object access protocol (SOAP) message format. SOAP is a protocol for exchange of information in a decentralized, distributed environment. It is an XML based protocol that includes three parts: an envelope that defines a framework for describing what is in a message and how to process it, a set of encoding rules for expressing instances of application-defined datatypes, and a convention for representing remote procedure calls and responses.

In a service loop beginning at block 906, for each web service 104 referenced in a test script 114, an instance of a web service object 1004 is created (block 908). At block 910, an instance of a header data object 1010 is created to supply header information for the web service 104, if desired. The header information may include a SOAP header which acts as a global argument to the web service 104. At block 912, credentials are applied to the test script 114, if desired. For instance, credentials may include a user name and password used to access a web service 104.

In a method loop beginning at block 914, for each method 110 on the service as indicated by the test script 114, test method objects 1006 are filtered to ensure that a proper method is used (916). For example, the test engine 208 may examine the test data file 214 to identify a method object 1006 which may have been overlooked or improperly included within a wrong web service object 1004.

In test case loop beginning at block 918, for each test case, a method object 1006 is invoked with specified argument data as a test case object 1008 (block 920). For example, a test case object 1008 loop invokes a method described by a parent method object 1006 to supply “query Ulysses”.

At block 922, the test engine 208 verifies a result 218 of the test case, such as through use of a test verifier 216 as described in relation to FIG. 5. At block 924, the test engine 208 saves the test results to an aggregate result file 504. After completion of the test case loop beginning at block 918 for each test case object 1008, and the method loop beginning at block 916 for each method object 1006, the test engine 208 reports testing results. The test engine 208 may report percentage of successful tests, report particular tests that failed, and the like. The test script 114 may include multiple web service objects 1004 to test multiple web services. Therefore, the test engine 208 may continue progressing through the web services loop beginning at block 906. In this way, the test engine 208 may test multiple web services 104 in an automated manner.

### Exemplary Test Script Having Test Data

Following is an example of a test script 114 having test data 212. The exemplary test script is formatted as a standard SOAP message. This provides an ability to test a SOAP client's serialization and deserialization code, because the exemplary test script contains a wider variety of constructs than an average SOAP message.

The exemplary test script demonstrates support for multiple methods, intrinsic and custom data types, expected results and disabling of test cases. Following the exemplary test script 114 is a discussion that examines relevant portions of the structure.

```
<?xml version=“1.0” encoding=“utf-8”?>
<soap:Envelope xmlns:soap=“http://schemas.xmlsoap.org/soap/envelope/”
xmlns:xsi=“http://www.w3.org/2001/XMLSchema-instance”
xmlns:xsd=“http://www.w3.org/2001/XMLSchema”>
  <soap:Body>
    <WSTest xmlns=“http://tempuri.org/”>
      <Service name=“WSDLInteropTestDocLitService”>
        <Method name=“echoString”>
          <Test name=“echoString( )”>
            <Argument type=“System.String|mscorlib”
name=“echoStringParam” direction=“In”>
              <in xsi:type=“xsd:string”>The Giants
              win the pennant!</in>
            </Argument>
            <expectedResult type=“System.String|mscorlib”>
              <out xsi:type=“xsd:string”>The Giants win the
pennant!</out>
            </expectedResult>
          </Test>
        </Method>
        <Method name=“echoStruct”>
          <Test name=“echoStruct( )”>
            <Argument
type=
“SOAPStruct|MSSOAPToolkit30GroupDInteropTestDocLit.cs.Proxy”
name=“echoStructParam” direction=“In”>
              <in xmlns:q1=“http://soapinterop.org/xsd”
xsi:type=“q1:SOAPStruct”>
                <q1:varFloat>−0.01</q1:varFloat>
                <q1:varInt>5867303</q1:varInt>
                <q1:varString>Thou art the heir of Keb and of the
sovereignty of the Two Lands</q1:varString>
              </in>
            </Argument>
            <expectedResult
type=
“SOAPStruct|MSSOAPToolkit30GroupDInteropTestDocLit.cs.Proxy”>
              <out xmlns:q2=“http://soapinterop.org/xsd”
xsi:type=“q2:SOAPStruct”>
                <q2:varFloat>−0.01</q2:varFloat>
                <q2:varInt>5867303</q2:varInt>
                <q2:varString>Thou art the heir of Keb and of the
sovereignty of the Two Lands</q2:varString>
              </out>
            </expectedResult>
          </Test>
        </Method>
        <Method name=“echoVoid”>
          <Test name=“echoVoid( )” enabled=“false”>
            <expectedResult />
          </Test>
        </Method>
      </Service>
    </WSTest>
  </soap:Body>
</soap:Envelope>
```

The sections below extract the relevant portions of the exemplary test script and describe them in detail.

Web Service Test (WSTest)

A WSTest node, corresponding to the WSTest parent object 1002, is a parent of a test data schema. The first three lines in the exemplary test script wrap data of the script into a SOAP message. The WSTest node contains an ‘xmlns’ (namespace) attribute and one or more Service nodes.

<WSTest xmlns=“http://tempuri.org/”>

By default, the ‘xmlns’ attribute is set to the test namespace (http://tempuri.org/).

Service

A ‘Service’ node, which corresponds to the web service object 1004, contains a ‘name’ attribute, three optional credentials attributes (‘username’, ‘password’ and ‘domain’) and one or more ‘Method’ nodes.

<Service name=“WSDLInteropTestDocLitService”>

The value of the ‘name’ attribute is a name of a service class as it appears in code.

<Service name=“MyService” username=“MyName”
password=“MyPassword”
domain=“MyDomain”>

The presence of credentials attributes causes the test engine 208 to use these credentials when calling the web service 104.

Header

A ‘Header’ node, corresponding to the header object 1010, is a child of the ‘service’ node and represents a global argument that is set on the web service client Headers are optional for most services and if present may contain a ‘name’ attribute.

<Header name=“OptionalHeader” />

a value of the ‘name’ attribute is a name of a header object as it appears in code.

If a header is used by a service, it may contain ‘type’ and ‘direction’ attributes and either an ‘In’ or ‘Out’ child node, depending on a value of a ‘direction’ attribute.

<Header type=“System.String|mscorlib” name=“ProductName”
direction=“In”>
<in xsi:type=“xsd:string”>WSTest</in>
</Header>

The value of the ‘type’ attribute is in the form of <type name>|<assembly> where <type name> is a name of the type as it appears in code and <assembly> is a name of the assembly providing the type.

The value of the ‘direction’ attribute is typically “In”, indicating that this parameter is input data to the method.

The ‘in’ node specifies a type for the data in SOAP message format using an ‘xsi:type’ attribute. The header's data is the node's value.

Headers may be implemented using both intrinsic and custom types. The example below demonstrates a simple custom type header.

```
<Header type=“VersionInformation|SampleService.cs.Proxy”
name=“serviceVersion” direction=“In”>
  <in xmlns:q1=“http://tempuri.org/” xsi:type=“q1: VersionInformation”>
    <q1:productVersion>1.04</q1: productVersion >
    <q1:buildNumber>45</q1:buildNumber>
    <q1:revision>6</q1:revision>
  </in>
</Header>
```

When a ‘Header’ node has the ‘direction’ attribute set to “Out”, there is no ‘type’ attribute and no ‘in’ child node. This indicates to the test engine 208 that an instance of this object is not to be created, because one will be created on deserialization on return from invoking a method.

<Header name=“OutputHeader” direction=“Out” />

Method

A ‘Method’ node, corresponding to the method object 1006, contains a ‘name’ attribute and one or more ‘Test’ nodes.

<Method name=“echoString”>

The value of the ‘name’ attribute is the name of the method as it appears in code.

Test

A ‘Test’ node, corresponding to the test case object 1008, contains a ‘name’ attribute, three optional test behavior attributes (‘expectException’, ‘verifyTypeOnly’ and ‘enabled’), zero or more ‘Argument nodes’, and an optional ‘expectedResult’ node.

<Test name=“echoString( )”>

A value of the ‘name’ attribute is user provided. By default, it is an empty string, and is intended to be a description of a test case.

<Test name=“echoVoid( )” enabled=“false”>

Setting the ‘enabled’ attribute to false causes the test engine 208 to skip over a corresponding test case. This is useful when a user wishes to bypass a particular test case, e.g. because test data is not currently defined, yet does not wish to remove it from the test data file 214. By default, the ‘enabled’ attribute will not appear in the ‘Test’ node and its value will be true.

<Test name=“Expect exception from this method” expectException=
“true” >

Setting a value of an ‘expectException’ attribute to true instructs the test engine 208 to report a failure if a method 110 does not throw an exception in response to provided test data 212. By default, the ‘expectException’ attribute will not appear in the ‘Test’ node and its value will be false.

<Test name=“Method returns time sensitive data” verifyTypeOnly=“
true”>

Setting a value of a ‘verifyTypeOnly’ attribute to true tells the test engine 208 that a result 218 of a test case may vary from one test pass to another, such as currency exchange rates, and therefore to only check that a correct type of data was returned, as described previously in relation to FIG. 5. By default, the ‘verifyTypeOnly’ attribute will not appear in the ‘Test’ node and its value will be false.

Argument

An ‘Argument’ node, corresponding to the argument object 1012, contains a ‘name’ attribute, a ‘direction’ attribute, an optional ‘type’ attribute and an optional ‘in’ node.

<Argument type=“System.String|mscorlib” name=“echoStringParam”
direction=“In”>
<in xsi:type=“xsd:string”>The Giants win the pennant!</in>
</Argument>

The value of the ‘name’ attribute is a name of the argument as it appears in code.

The value of a ‘type’ attribute is in the form of <type name>|<assembly> where <type name> is a name of a type as it appears in code and <assembly> is a name of the assembly providing the type.

The value of a ‘direction’ attribute is typically “In”, indicating that this parameter is input data to the method.

The ‘in’ node specifies a type of data in SOAP message format using an ‘xsi:type’ attribute. The argument's data is the node's value.

```
<Argument
type=“SOAPStruct|MSSOAPToolkit30GroupDInteropTestDocLit.cs.
Proxy”
name=“echoStructParam” direction=“In”>
    <in xmlns:q1=“http://soapinterop.org/xsd” xsi:type=“q1:
    SOAPStruct”>
        <q1:varFloat>−0.01</q1:varFloat>
        <q1:varInt>5867303</q1:varInt>
        <q1:varString>Thou art the heir of Keb and of the sovereignty
of the Two Lands</q1:varString>
    </in>
</Argument>
```

The above example demonstrates a custom data type as specified by a proxy 210, such as MSSoapToolkit 30 GroupDInteropTestDocLit. cs. Proxy. In this instance, an ‘in’ node contains an additional attribute (‘xmlns’) that specifies a namespace for a data type.

The child nodes of ‘in’ contain each field in a custom type. In this example, the fields are intrinsic types, though custom types may be successfully nested.

<Argument type=“System.Single|mscorlib” name=“byRefFloatParam”
direction=“In Out”>
<in xsi:type=“xsd:float”>1</in>
</Argument>

For arguments that are passed by reference (serve as both input and output for a method), a value of the ‘direction’ attribute will be set to “In Out” and a value of the ‘in’ node will be set to a generic value (often “1”).

<Argument name=“outStringParam” direction=“Out” />

When an ‘Argument’ node has the ‘direction’ attribute set to “Out”, there is no ‘type’ attribute and no ‘in’ child node. This indicates to the test engine 208 that an instance of this object is not created at this time, because one will be created on deserialization on return from invoking a method.

Expected Result

An expected result node, corresponding to the expect result object 1014, contains an optional ‘type’ attribute and an optional ‘out’ attribute.

<expectedResult type=“System.String|mscorlib”>
<out xsi:type=“xsd:string”>The Giants win the pennant!</out>
</expectedResult>

A value of a ‘type’ attribute is in a form <type name>|<assembly> where <type name> is a name of the type as it appears in code and <assembly> is a name of an assembly providing the type. An ‘out’ node specifies a type of the data in SOAP message format using the ‘xsi:type’ attribute and contains the data as the nodes value.

<expectedResult />

In the case of a method with no return value (a “void method”), the ‘expectedResult’ node is empty (as shown above).

### Sample Test Script Having Results Data

After testing, a results file 218 is created with a file name in the form of <service>.Results.xml. This results file 218 contains data present in a test script 114 plus a result 218 of the testing. The sample data, below, is the result 218 from running the above exemplary test script through the test engine 208 when stored with a test script 114.

```
<?xml version=“1.0” encoding=“utf-8”?>
<soap:Envelope xmlns:soap=“http://schemas.xmlsoap.org/soap/envelope/”
xmlns:xsi=“http://www.w3.org/2001/XMLSchema-instance”
xmlns:xsd=“http://www.w3.org/2001/XMLSchema”>
  <soap:Body>
    <WSTest xmlns=“http://tempuri.org/”>
      <runStarted>2003-02-04T10:50:27.0732074-08:00</runStarted>
      <Service name=“WSDLInteropTestDocLitService”>
        <Method name=“echoString”>
          <Test name=“echoString( )”>
            <Argument type=“System.String|mscorlib”
name=“echoStringParam” direction=“In”>
              <in xsi:type=“xsd:string”>The Giants win the pennant!
              </in>
            </Argument>
            <expectedResult type=“System.String|mscorlib”>
              <out xsi:type=“xsd:string”>The Giants win the
pennant!</out>
            </expectedResult>
            <Result type=“System.String|mscorlib”>
              <out xsi:type=“xsd:string”>The Giants win the
pennant!</out>
            </Result>
          </Test>
        </Method>
        <Method name=“echoStruct”>
          <Test name=“echoStruct( )”>
            <Argument
type=“SOAPStruct|MSSOAPToolkit30GroupDInteropTestDocLit.cs.
Proxy”
name=“echoStructParam” direction=“In”>
              <in xmlns:q1=“http://soapinterop.org/xsd”
xsi:type=“q1:SOAPStruct”>
                <q1:varFloat>−0.01</q1:varFloat>
                <q1:varInt>5867303</q1:varInt>
                <q1:varString>Thou art the heir of Keb and of the
sovereignty of the Two Lands</q1:varString>
              </in>
            </Argument>
            <expectedResult
type=“SOAPStruct|MSSOAPToolkit30GroupDInteropTestDocLit.cs.
Proxy”>
              <out xmlns:q2=“http://soapinterop.org/xsd”
xsi:type=“q2:SOAPStruct”>
                <q2:varFloat>−0.01</q2:varFloat>
                <q2:varInt>5867303</q2:varInt>
                <q2:varString>Thou art the heir of Keb and of the
sovereignty of the Two Lands</q2:varString>
              </out>
            </expectedResult>
            <Result
type=“SOAPStruct|MSSOAPToolkit30GroupDInteropTestDocLit.cs.
Proxy”>
            <out xmlns:q3=“http://soapinterop.org/xsd”
xsi:type=“q3:SOAPStruct”>
                <q3:varFloat>−0.01</q3:varFloat>
                <q3:varInt>5867303</q3:varInt>
                <q3:varString>Thou art the heir of Keb and of the
sovereignty of the Two Lands</q3:varString>
              </out>
            </Result>
          </Test>
        </Method>
        <Method name=“echoVoid”>
          <Test name=“echoVoid( )”>
            <expectedResult />
            <Result />
          </Test>
        </Method>
      </Service>
    </WSTest>
  </soap:Body>
</soap:Envelope>
```

The sections below describe data added to a results file 218 after testing.

WSTest

The additional data added to the ‘WSTest’ node provides data pertaining to the environment in which the tests were run.

<runStarted>2003-02-04T10:50:27.0732074-08:00</runStarted>

The ‘runStarted’ node contains the date and time (in the local time zone) of when a test was started.

Header

After testing, ‘Header’ nodes may contain output data, as shown below.

<Header type=“System.Int32|mscorlib” name=“MagicNumber” direction=
“Out”>
<out xsi:type=“xsd:int”>715</out>
</Header>

In the above example, the ‘MagicHeader’ header node now contains a ‘type’ attribiute and an ‘out’ child node. The ‘out’ node contains an actual value of the header as returned.

Test

After testing, the ‘Test’ node contains either a ‘Result’ or an ‘Exception’ node based on a result of invoking the method.

<Result type=“System.String|mscorlib”>
<out xsi:type=“xsd:string”>The Giants win the pennant!</out>
</Result>

The ‘Result’ node, corresponding to the result object 1016, is structured similarly to the ‘expectedResult’ node discussed previously.

```
<exception Type=“System.Reflection.TargetInvocationException”
Message=“Exception has been thrown by the target of an invocation.”>
    <InnerException Type=“System.Web.Services.Protocols.
    SoapException”
Message=“WSDLOperation: GetIDsOfNames failed: no dispatch ID for
method NoSuchMethod found” />
</exception>
```

In an event that invoking the method resulted in an exception, the ‘Test’ node contains an ‘exception’ node, corresponding to the exception info object 1018. The ‘exception’ node contains attributes for the type (‘Type’) of exception and the message contained in the exception object (‘Message’).

Argument

After testing, ‘Argument’ nodes may contain output data, as shown below.

<Argument type=“System.Int32|mscorlib” name=“outputInteger”
direction=“Out”>
<out xsi:type=“xsd:int”>715</out>
</Argument>

In the above example, the ‘outputInteger’ argument node now contains a ‘type’ attribute and an ‘out’ child node. The ‘out’ node contains the value that was returned to the caller via the out argument.

### Exemplary Operating Environment

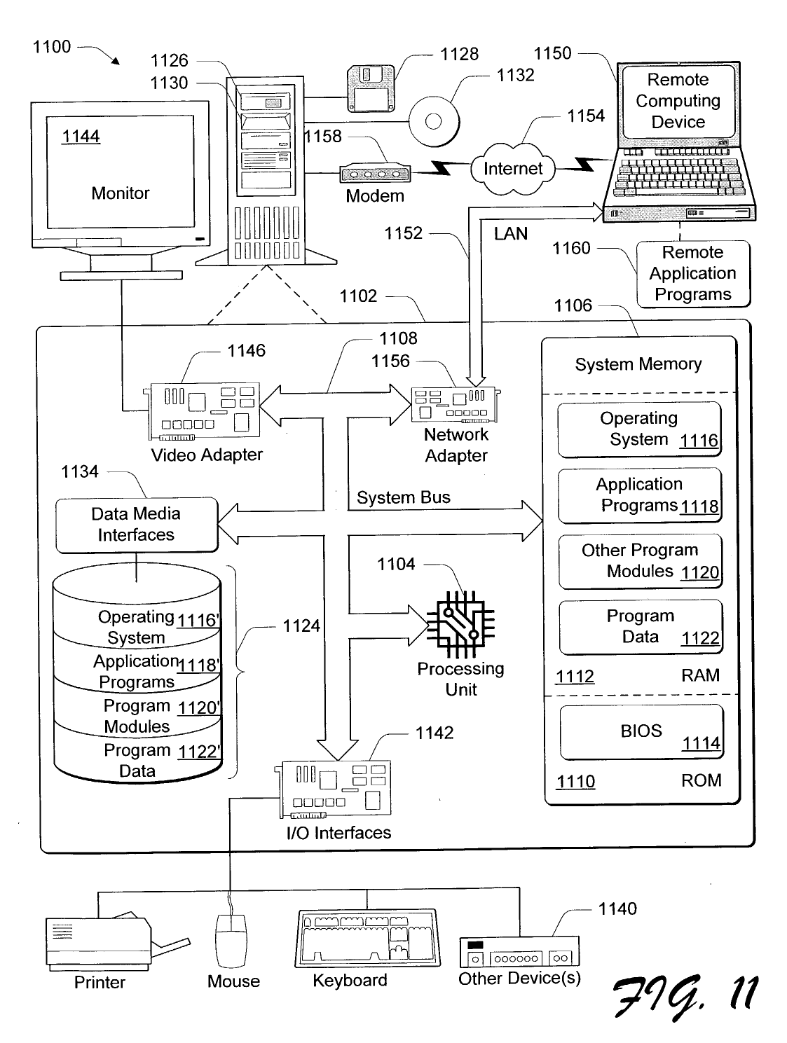

The various components and functionality described herein are implemented with a number of individual computers. FIG. 11 shows components of a typical example of a computer environment 1100, including a computer, referred by to reference numeral 1102. The components shown in FIG. 11 are only examples, and are not intended to suggest any limitation as to the scope of the functionality of the invention; the invention is not necessarily dependent on the features shown in FIG. 11.

Generally, various different general purpose or special purpose computing system configurations can be used. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The functionality of the computers is embodied in many cases by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 11, the components of computer 1102 may include, but are not limited to, a processing unit 1104, a system memory 1106, and a system bus 1108 that couples various system components including the system memory to the processing unit 1104. The system bus 1108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Computer 1102 typically includes a variety of computer-readable media. Computer-readable media can be any available media that can be accessed by computer 1102 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1102. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1106 includes computer storage media in the form of volatile and/or nonvolatile memory such as read only memory (ROM) 1110 and random access memory (RAM) 1112. A basic input/output system 1114 (BIOS), containing the basic routines that help to transfer information between elements within computer 1102, such as during start-up, is typically stored in ROM 1110. RAM 1112 typically contains data and/or program modules that are immediately accessible to and/or presently being operated on by processing unit 1104. By way of example, and not limitation, FIG. 11 illustrates operating system 1116, application programs 1118, other program modules 1120, and program data 1122.

The computer 1102 may also include other removable/non-removable, volatile/nonvolatile computer storage media. By way of example only, FIG. 11 illustrates a hard disk drive 1124 that reads from or writes to non-removable, nonvolatile magnetic media, a magnetic disk drive 1126 that reads from or writes to a removable, nonvolatile magnetic disk 1128, and an optical disk drive 1130 that reads from or writes to a removable, nonvolatile optical disk 1132 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1124 is typically connected to the system bus 1108 through a non-removable memory interface such as data media interface 1134, and magnetic disk drive 1126 and optical disk drive 1130 are typically connected to the system bus 1108 by a removable memory interface.

The drives and their associated computer storage media discussed above and illustrated in FIG. 11 provide storage of computer-readable instructions, data structures, program modules, and other data for computer 1102. In FIG. 11, for example, hard disk drive 1124 is illustrated as storing operating system 1116′, application programs 1118′, other program modules 1120′, and program data 1122′. Note that these components can either be the same as or different from operating system 1116, application programs 1118, other program modules 1120, and program data 1122. Operating system 1116′, application programs 1118′, other program modules 1120′, and program data 1122′ are given different numbers here to illustrate that, at a minimum, they are different copies. A user may enter commands and information into the computer 1102 through input devices such as a keyboard 1136 and pointing device 1138, commonly referred to as a mouse, trackball, or touch pad. Other input devices (not shown) may include a microphone, joystick, game pad, satellite dish, scanner, or the like. These and other input devices 1140 are often connected to the processing unit 1102 through an input/output (I/O) interface 1142 that is coupled to the system bus, but may be connected by other interface and bus structures, such as a parallel port, game port, or a universal serial bus (USB). A monitor 1144 or other type of display device is also connected to the system bus 1108 via an interface, such as a video adapter 1146. In addition to the monitor 1144, computers may also include other peripheral output devices (e.g., speakers) and one or more printers 1148, which may be connected through the I/O interface 1142.

The computer may operate in a networked environment using logical connections to one or more remote computers, such as a remote computing device 1150. The remote computing device 1150 may be a personal computer, a server, a router, a network PC, a peer device or other common network node, and typically includes many or all of the elements described above relative to computer 1102. The logical connections depicted in FIG. 11 include a local area network (LAN) 1152 and a wide area network (WAN) 1154. Although the WAN 1154 shown in FIG. 11 is the Internet, the WAN 1154 may also include other networks. Such networking environments are commonplace in offices, enterprise-wide computer networks, intranets, and the like.

When used in a LAN networking environment, the computer 1102 is connected to the LAN 1152 through a network interface or adapter 1156. When used in a WAN networking environment, the computer 1102 typically includes a modem 1158 or other means for establishing communications over the Internet 1154. The modem 1158, which may be internal or external, may be connected to the system bus 1108 via the I/O interface 1142, or other appropriate mechanism. In a networked environment, program modules depicted relative to the computer 1102, or portions thereof, may be stored in the remote computing device 1150. By way of example, and not limitation, FIG. 11 illustrates remote application programs 1160 as residing on remote computing device 1150. It will be appreciated that the network connections shown are exemplary and other means of establishing a communications link between the computers may be used.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method, comprising:
generating a test script having an indication of a method available from a web service; and
testing the web service by invoking the method indicated within the test script.

2. A method as described in claim 1, wherein the testing is performed automatically using the test script.

3. A method as described in claim 1, wherein the generating comprises forming a proxy that exposes the method and creating the test script using the proxy.

4. A method as described in claim 1, wherein the generating comprises:
forming a proxy from a WSDL document obtained from the web service, the WSDL document indicating the method available from the web service, an argument expected, and data type for the method, and output data type for the method; and
creating the test script using the proxy.

5. A method as described in claim 1, further comprising automatically verifying a result of the testing by comparing the result with an expected result.

6. A method as described in claim 1, wherein the test script is an XML file having markup tags corresponding to the web service and the method.

7. One or more computer-readable media comprising computer-executable instructions that, when executed, perform the method as recited in claim 1.

8. A method, comprising:
generating a test script from a proxy that exposes a method available from a web service, the test script having the method exposed by the proxy;
supplying test data to the test script for use in testing the method; and
invoking the method available from the web service using the test script with the test data.

9. A method as described in claim 8, wherein the invoking is performed automatically using the test script.

10. A method as described in claim 8, wherein the generating comprises:
forming a proxy from a WSDL document obtained from the web service, the WSDL document indicating the method available from the web service, an argument expected, and data type for the method, and output data type for the method; and
creating the test script using the proxy.

11. A method as described in claim 8, further comprising automatically verifying results of the invoking.

12. A method as described in claim 8, wherein the test script is an XML file having markup tags corresponding to the web service and method.

13. A method as described in claim 8, wherein the supplying includes automatically providing test data from a test data file which corresponds to the method available from the web service.

14. One or more computer-readable media comprising computer-executable instructions that, when executed, perform the method as recited in claim 8.

15. A method, comprising:
automatically producing a test script having test data;
testing a web service using the test script with the test data; and
verifying a result of the testing.

16. A method as described in claim 15, wherein the producing of the test script includes generating the test script from a proxy that exposes the method available from a web service.

17. A method as described in claim 15, further comprising:
forming a proxy from a WSDL document obtained from the web service, the WSDL document indicating the method available from the web service, an argument expected, and data type for the method, and output data type for the method; and
creating the test script using the proxy.

18. A method as described in claim 15, wherein the test script is an XML file having markup tags corresponding to the web service.

19. A method as described in claim 15, wherein the verifying includes comparing the result of the testing with an expected result.

20. One or more computer-readable media comprising computer-executable instructions that, when executed, perform the method as recited in claim 15.

21. A method, comprising:
creating a proxy from a web services description language (WSDL) document obtained from a web service, the WSDL document indicating a method available from the web service;
generating a test script from the proxy, the test script having the method exposed by the proxy;
supplying test data to the test script;
invoking the method available from the web service using the test script with the test data;
receiving a result of the invoking; and
verifying the result with an expected result.

22. One or more computer-readable media comprising computer-executable instructions that, when executed, perform the method as recited in claim 21.

23. A method, comprising:
invoking a method available from a web service in a first instance using a test script;
storing a result of the invoking in the first instance as an expected result;
invoking the method available from the web service in a second instance using the test script; and
verifying a result of the invoking of the method available from the web service in the second instance with the expected result.

24. A method as described in claim 23, wherein the invoking of the method in the first instance is implemented by a computer, and the invoking of the method in the second instance is implemented by a low resource client.

25. A method as described in claim 23, wherein the invoking of the method in the first instance is performed at a first time, and the invoking of the method in the second instance is performed at a second time subsequent to the first time.

26. A method as described in claim 23, where the test script contains the method and test data for testing the method when the method is invoked.

27. A method as described in claim 23, wherein the invoking in at least one of the first instance and the second instance is performed automatically using the test script.

28. A method as described in claim 23, wherein the verifying includes comparing data types of the first and second results.

29. A method as described in claim 23, wherein the test script is an XML file having markup tags corresponding to the web service and the method.

30. One or more computer-readable media comprising computer-executable instructions that, when executed, perform the method as recited in claim 23.

31. A system, comprising:
a server implementing a web service, the web service having a method; and
a testing device having a memory and a processor and being communicatively coupled to the server, the testing device being configured to automatically test the web service by generating a test script to test the method of the web service using the test script.

32. A system as described in claim 31, wherein the testing device forms a proxy that exposes the method of the web service, the testing device invoking the method.

33. A system as described in claim 31, wherein the testing device automatically verifies the test.

34. A system as described in claim 31, wherein the test script is an XML file having markup tags corresponding to the web service and the method.

35. A system as described in claim 31, wherein the testing device utilizes test data with the test script.

36. A testing device, comprising:
a test script generator that generates a test script from a proxy that exposes a method of the web service, the test script having the method exposed by the proxy; and
a test engine that tests the method of the web service by invoking the method of the web service using the test script.

37. A testing device as described in claim 36, wherein the test engine tests the method automatically using the test script.

38. A testing device as described in claim 36, wherein the test engine invokes the method of the web service using the proxy.

39. A testing device as described in claim 36, wherein the test engine invokes the method of the web service by creating an instance of the proxy and invoking the proxy such that when the proxy is invoked, the proxy calls the web service and invokes the method of the web service.

40. A testing device as described in claim 36, wherein the test engine includes a test verifier that automatically verifies a result of the test.

41. A testing device as described in claim 36, wherein the test script is an XML file having markup tags corresponding to the web service and the method.

42. A testing device as described in claim 36, further comprising a test data file with test data for the method, wherein the test engine supplies the test data from the test data file to the test script.

43. A testing device as described in claim 36, further comprising:
a memory and a processor; and
the test script generator and the test engine being implemented as software modules stored in the memory and executed by the processor.

44. A computer-readable medium comprising computer-executable instructions that, when executed, direct a computer to:
automatically generate a test script to test a method available from a web service; and
automatically test the web service by invoking the method available from the web service using the test script.

45. A computer-readable medium as described in claim 44, wherein the test script is an XML file having markup tags corresponding to the web service and the method.

46. A computer-readable medium as described in claim 44, wherein the computer-readable medium has further instructions that when executed, supply test data to the test script for use in testing the method available from the web service.

47. A computer-readable medium comprising computer-executable instructions that, when executed, direct a computer to:
produce a test script;
invoke a method of a web service using the test script; and
verify a result of the invocation of the method of the web service.

48. A computer-readable medium as described in claim 47, wherein the method of the web service is invoked automatically using the test script.

49. A computer-readable medium as described in claim 47, wherein the computer-readable medium has further instructions that when executed, automatically verify results of the test.

50. A computer-readable medium as described in claim 47, wherein the computer-readable medium has further instructions that when executed, automatically verify a result of the invoking of the method of the web service by comparing data of the result with data of an expected result.

51. A computer-readable medium as described in claim 47, wherein the test script is an XML file having markup tags corresponding to the web service and the method.

52. A testing device, comprising:
means for generating a test script having a method available from a web service to be tested; and
means for supplying test data to the test script and testing the method using the test script with the test data.
